(19) United States
(12) Patent Application Publication
(10) Pub. No.: US 2025/0390645 A1
(43) Pub. Date: Dec. 25, 2025

(54) METHODS, LARGE MODEL-BASED SYSTEMS OF INTERNET OF THINGS, AND STORAGE MEDIA FOR EMERGENCY SUPERVISION OF BRIDGES IN SMART CITIES

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/304,612

(22) Filed: Aug. 20, 2025

(30) Foreign Application Priority Data
Jul. 21, 2025 (CN) 202510998450.2

(51) Int. Cl. G06F 30/27; G06F 119/02; G06Q 50/26; G16Y 40/10; G16Y 40/50

(52) U.S. Cl. CPC G06F 30/27; G16Y 40/10; G16Y 40/50; G06F 2119/02; G06Q 50/26

(57) ABSTRACT

Provided are a method, a large model-based system of Internet of Things (IoT), and a storage medium for emergency supervision of a bridge in a smart city. The method is executed by an emergency supervision management platform of the large model-based system of IoT for emergency supervision of the bridge in the smart city. The method includes: determining a bridge health value of the bridge based on sensing data of a plurality of target locations on the bridge; determining a bridge safety coefficient based on first traffic flow data of the bridge; determining a bridge reliability level based on the bridge health value and the bridge safety coefficient; in response to the bridge reliability level satisfying a first predetermined condition, generating at least one of a signal light regulation instruction, a maintenance regulation instruction, or a traffic regulation instruction.

### CROSS-REFERENCE TO RELATED APPLICATIONS

This application claims priority to Chinese application No. 202510998450.2, filed on Jul. 21, 2025, the entire contents of which are incorporated herein by reference.

### TECHNICAL FIELD

The present disclosure relates to the technical field of bridge emergency supervision, and in particular relates to a method, a large model-based system of Internet of Things, and a storage medium for emergency supervision of a bridge in a smart city.

### BACKGROUND

Bridge emergency supervision is a core aspect of safeguarding the safe operation of transportation infrastructures, and is currently facing multi-dimensional challenges. From the perspective of risk sources, bridge emergency supervision involves static hazards (e.g., material aging and outdated design standards) and dynamic threats (e.g., overloaded transportation and extreme weather conditions). In addition, at the management level, bridge emergency supervision suffers from technical shortcomings such as insufficient inspection coverage, untimely maintenance, and lack of data-sharing mechanisms, leading to risks like vortex-induced vibrations and collapses, which may further result in secondary disasters. Under these circumstances, the issue of reliability supervision for bridges demands heightened attention.

Therefore, it is desirable to provide a method, a large model-based system of Internet of Things (IoT), and a storage medium for emergency supervision of a bridge in a smart city. By enabling data interaction among IoT platforms, relevant bridge parameters are monitored and corresponding measures are promptly implemented, thereby improving bridge reliability and safety.

### SUMMARY

One or more embodiments of the present disclosure provide a method for emergency supervision of a bridge in a smart city. The method includes: determining a bridge health value of the bridge based on sensing data of a plurality of target locations on the bridge; determining a bridge safety coefficient based on first traffic flow data of the bridge; determining a bridge reliability level based on the bridge health value and the bridge safety coefficient; in response to the bridge reliability level satisfying a first predetermined condition, generating at least one of a signal light regulation instruction, a maintenance regulation instruction, or a traffic regulation instruction; wherein the signal light regulation instruction is configured to control each of a plurality of traffic signal lights to display a predetermined color in a predetermined time period; the maintenance regulation instruction is configured to control a plurality of maintenance robots to inject an adhesive and/or perform steel plate bonding at predetermined locations on the bridge; and the traffic regulation instruction is configured to control a plurality of smart barricades to be raised.

One or more embodiments of the present disclosure provide a large model-based system of Internet of Things (IoT) for emergency supervision of a bridge in a smart city. The system includes an emergency supervision user platform, an emergency supervision service platform, an emergency supervision management platform, an emergency supervision sensor network platform, and an emergency supervision object platform; the emergency supervision management platform is configured to: determine the bridge health value of the bridge based on sensing data of the plurality of target locations on the bridge; determine the bridge safety coefficient based on the first traffic flow data of the bridge; determine the bridge reliability level based on the bridge health value and the bridge safety coefficient; in response to the bridge reliability level satisfying the first predetermined condition, generate at least one of the signal light regulation instruction, the maintenance regulation instruction, or the traffic regulation instruction; wherein the signal light regulation instruction is configured to control each of the plurality of traffic signal lights to display the predetermined color in the predetermined time period; the maintenance regulation instruction is configured to control the plurality of maintenance robots to inject the adhesive and/or perform the steel plate bonding at the predetermined locations on the bridge; and the traffic regulation instruction is configured to control the plurality of smart barricades to be raised.

One or more embodiments of the present disclosure provide a non-transitory computer-readable storage medium storing computer instructions, wherein when reading the computer instructions in the storage medium, a computer implements the method for emergency supervision of the bridge in the smart city provided in the present disclosure.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering denotes the same structure, wherein:

FIG. 1 is a block diagram illustrating an exemplary platform structure of a large model-based system of Internet of Things (IoT) for emergency supervision of a bridge in a smart city according to some embodiments of the present disclosure;

FIG. 2 is a flowchart illustrating an exemplary process for emergency supervision of a bridge in a smart city according to some embodiments of the present disclosure; and

FIG. 3 is schematic diagram illustrating an exemplary damage prediction model according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or”, as used herein, is merely a way of describing the associative relationship of an associated object, indicating that three relationships can exist, e.g., A and/or B, which may be represented as: An alone, both A and B, and B alone. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

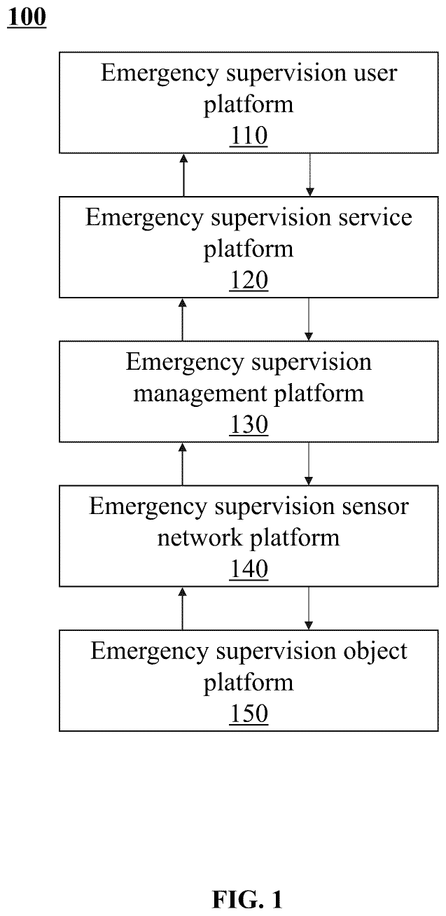

FIG. 1 is a block diagram illustrating an exemplary platform structure of a large model-based system of Internet of Things (IoT) for emergency supervision of a bridge in a smart city according to some embodiments of the present disclosure.

Some embodiments of the disclosure provide a structure of a large model-based system of Internet of Things (IoT) for emergency supervision of a bridge in a smart city. As shown in FIG. 1, a system 100 includes an emergency supervision user platform 110, an emergency supervision service platform 120, an emergency supervision management platform 130, an emergency supervision sensor network platform 140, and an emergency supervision object platform 150.

The emergency supervision user platform 110 refers to a platform that interacts with a user (e.g., supervision personnel). In some embodiments, the emergency supervision user platform 110 includes a terminal device. For example, the terminal device may include a mobile device, a tablet, a console, etc. The emergency supervision user platform 110 may interact bi-directionally with the emergency supervision service platform 120.

The emergency supervision service platform 120 refers to a platform for receiving and transmitting data and/or information. In some embodiments, the emergency supervision service platform 120 is configured as a server or a processor. The emergency supervision service platform 120 may interact bi-directionally with the emergency supervision user platform 110 and the emergency supervision management platform 130.

The emergency supervision management platform 130 refers to an integrated management platform that manages and coordinates connection and collaboration among a plurality of platforms. In some embodiments, the emergency supervision management platform 130 is configured as a server or a processor. The emergency supervision management platform 130 may interact bi-directionally with the emergency supervision service platform 120 and the emergency supervision sensor network platform 140. For example, the emergency supervision management platform 130 may obtain sensing data from the emergency supervision object platform 150 through the emergency supervision sensor network platform 140. As another example, the emergency supervision management platform 130 may send a regulation instruction (e.g., a signal light regulation instruction, etc.) to the emergency supervision object platform 150 through the emergency supervision sensor network platform 140 to control the emergency supervision object platform 150 to perform relevant operations based on the regulation instruction.

In some embodiments, the emergency supervision management platform 130 is configured to: determine a bridge health value of the bridge based on the sensing data of a plurality of target locations on the bridge; determine a bridge safety coefficient based on first traffic flow data of the bridge; determine a bridge reliability level based on the bridge health value and the bridge safety coefficient; in response to the bridge reliability level satisfying a first predetermined condition, generate at least one of a signal light regulation instruction, a maintenance regulation instruction, or a traffic regulation instruction. The signal light regulation instruction is configured to control each of a plurality of traffic signal lights to display a predetermined color in a predetermined time period. The maintenance regulation instruction is configured to control a plurality of maintenance robots to inject an adhesive and/or perform steel plate bonding at predetermined locations on the bridge. The traffic regulation instruction is configured to control a plurality of smart barricades to be raised.

In some embodiments, the emergency supervision management platform 130 is further configured to determine a bridge safety coefficient through a simulation model based on first traffic flow data and first environmental data.

In some embodiments, the emergency supervision management platform 130 is further configured to determine bridge damage data of the bridge through a damage prediction model based on the sensing data, and determine the bridge health value based on the bridge damage data.

In some embodiments, an input of the damage prediction model includes a traffic flow impact feature and an environmental impact feature. The emergency supervision management platform 130 is further configured to: determine traffic flow-related data and environment-related data based on historical damage data, second traffic flow data, and second environmental data; and determine the traffic flow impact feature and the environmental impact feature based on the first traffic flow data, the first environmental data, the traffic flow-related data, and the environment-related data.

In some embodiments, the emergency supervision management platform 130 is further configured to: obtain an adjusted instruction by adjusting the signal light regulation instruction based on the traffic flow-related data, the bridge damage data, and reference damage data; and control each of the plurality of traffic signal lights to display the predetermined color in the predetermined time period based on the adjusted instruction.

In some embodiments, the emergency supervision management platform 130 is further configured to: in response to the bridge reliability level not satisfying a second predetermined condition, generate a monitoring and regulating instruction, arrange a plurality of sensors at a plurality of locations on the bridge based on the monitoring and regulating instruction, and control the plurality of sensors to perform data acquisition at a predetermined acquisition frequency and/or data upload at a predetermined upload frequency.

In some embodiments, the emergency supervision management platform 130 is further configured to: in response to the bridge reliability level not satisfying the second predetermined condition, generate the monitoring and regulating instruction based on the bridge damage data.

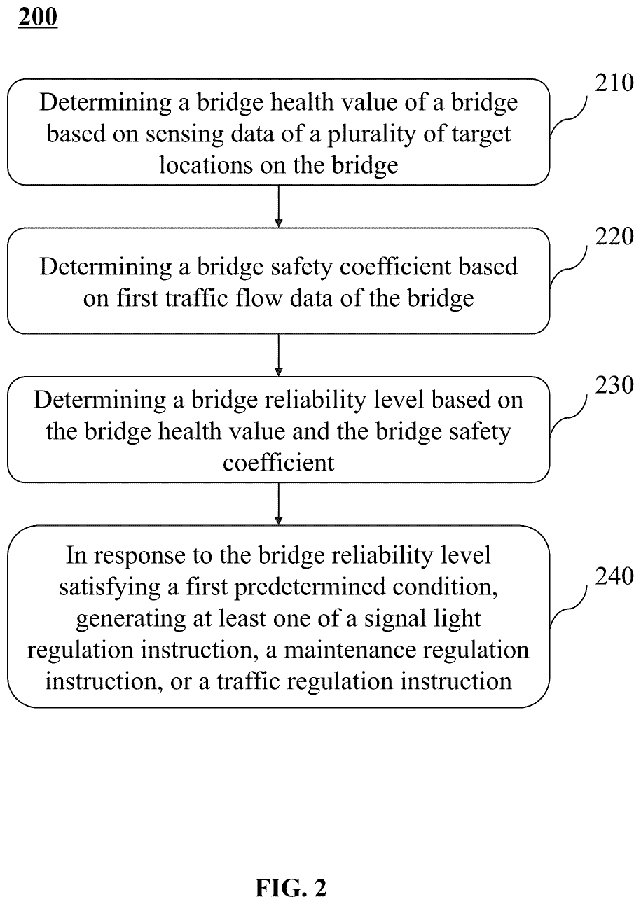

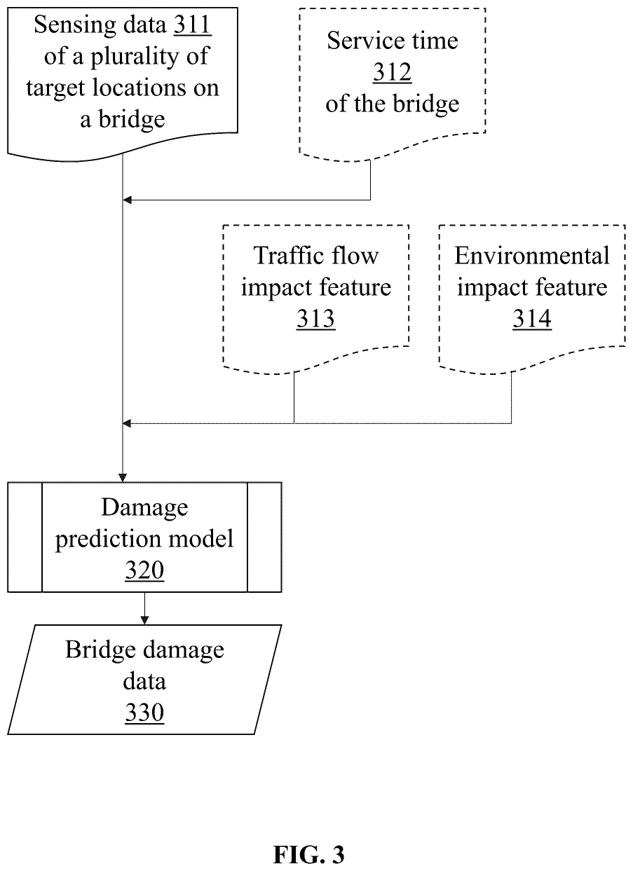

More descriptions regarding the emergency supervision management platform may be found in FIGS. 2-3 and related descriptions thereof.

The emergency supervision sensor network platform 140 refers to a platform for the integrated management of sensor information. In some embodiments, the emergency supervision sensor network platform 140 is configured as a communication network, a gateway, etc. The emergency supervision sensor network platform 140 may interact bi-directionally with the emergency supervision management platform 130 and the emergency supervision object platform 150.

The emergency supervision object platform 150 refers to a platform for generating supervision information and executing control information. In some embodiments, the emergency supervision object platform 150 may include a plurality of sensors, a plurality of traffic signal light, a plurality of maintenance robots, a plurality of smart barricades, etc. The emergency supervision object platform 150 may interact bi-directionally with the emergency supervision sensor network platform 140. For example, the emergency supervision object platform 150 may obtain the sensing data of the plurality of target locations on the bridge to upload the sensing data to the emergency supervision management platform 130 through the emergency supervision sensor network platform 140. As another example, the emergency supervision object platform 150 may perform a corresponding regulation operation in response to a regulation instruction sent by the emergency supervision management platform 130 through the emergency supervision sensor network platform 140.

In some embodiments of the present disclosure, performing emergency supervision on the bridge by using the IoT platforms can realize monitoring and rapid response to the safety conditions of the bridge. By intelligently analyzing the sensor data to automatically implement traffic control measures, potential hazards can be promptly eliminated, significantly enhancing bridge safety and reliability while reducing traffic accidents and ensuring the safety of pedestrians and vehicles. In addition, automated maintenance operations reduce labor costs and improve maintenance efficiency.

FIG. 2 is a flowchart illustrating an exemplary process for emergency supervision of a bridge in a smart city according to some embodiments of the present disclosure. As shown in FIG. 2, process 200 includes the following operations. In some embodiments, process 200 may be executed by the emergency supervision management platform 130 (hereinafter referred to as a management platform) at a predetermined interval. The predetermined interval may be set by a supervision personnel based on experience. For example, the predetermined interval may be 1 min, 5 min, etc.

In 210, a bridge health value of the bridge is determined based on sensing data of a plurality of target locations on the bridge.

A target location refers to a critical location that reflects a health status of the bridge. For example, the plurality of target locations may include a load-bearing location, a crack-prone location, a deformation-prone location, etc., on the bridge. In some embodiments, the supervision personnel may determine stress and deformation conditions of the bridge under a plurality of scenarios through simulation, etc., to determine the plurality of target locations (e.g., the load-bearing location, the crack-prone location, and the deformation-prone location, etc., on the bridge) and upload the plurality of target locations to the management platform.

The sensing data refers to data collected by a plurality of sensors. For example, the sensing data may include displacements, inclinations, dynamic strains, static strains, and vibration frequencies of the plurality of target locations on the bridge at a current time point. The dynamic strain of a target location refers to a strain produced at the target location on the bridge under a dynamic load (e.g., vehicular traffic, a wind load, an earthquake, etc.). The static strain of a target location refers to a strain produced at the target location on the bridge generated under a static load (e.g., a bridge self-weight, a temperature change, etc.).

In some embodiments, the plurality of sensors may include a plurality of Global Positioning System (GPS) displacement sensors, a plurality of inclination sensors, a plurality of strain gauges, and a plurality of acceleration sensors. The plurality of GPS displacement sensors may be configured to obtain the displacements of the plurality of target locations on the bridge at the current time point. The plurality of inclination sensors may be used to obtain the inclinations of the plurality of target locations on the bridge at the current time point. The plurality of strain gauges may be configured to obtain the dynamic strains and the static strains of the plurality of target locations on the bridge at the current time point. The plurality of acceleration sensors may be configured to obtain the vibration frequencies of the plurality of target locations on the bridge at the current time point.

The bridge health value may reflect the health status of the bridge. In some embodiments, the bridge health value may be expressed in a plurality of ways. For example, the bridge health value may be expressed as a health grade (e.g., the health grade may be categorized as A, B, and C, where A, B, and C denote a best health status, a moderate health status, and a worst health status of the bridge, respectively). As another example, the bridge health value may be expressed as a specific numerical value (e.g., a bridge health value of 90%, a bridge health value of 80%, etc.).

In some embodiments, the management platform may perform normalization processing on the sensing data of the plurality of target locations to obtain normalized data, and determine the bridge health value by querying a first predetermined table based on a difference between the normalized data and reference normalized data. The normalization processing may include Min-Max normalization, etc.

The first predetermined table may be constructed by the supervision personnel based on experience. The first predetermined table may map ranges of differences between different normalized data and reference normalized data to bridge health values. The reference normalized data may be data obtained after the normalization process is performed on the sensing data of the plurality of target locations when the bridge started to be put into service.

In some embodiments, the management platform may further determine bridge damage data of the bridge through a damage prediction model based on the sensing data, and determine the bridge health value based on the bridge damage data.

The bridge damage data refers to data related damages to the bridge. For example, the bridge damage data may include volumes, locations, etc., of cracks and deformations in the bridge. More descriptions regarding how to determine the bridge damage data through the damage prediction model may be found in FIG. 3 and related descriptions thereof.

In some embodiments, the management platform may take a ratio of a difference between a total volume of the bridge and a total volume of the cracks and the deformations in the bridge to the total volume of the bridge as the bridge health value.

In some embodiments of the present disclosure, by determining the bridge damage data through the damage prediction model based on the sensing data, and then determining the bridge health value, an extent of bridge damage or fatigue can be quantified, and the determined bridge health value is relatively accurate.

In 220, a bridge safety coefficient is determined based on first traffic flow data of the bridge.

The first traffic flow data refers to a sum of a pedestrian flow (or a count of pedestrians) and a vehicle flow (or a count of vehicles), etc., passing over the bridge at a plurality of historical time points in a predetermined time period prior to the current time point. The predetermined time period may be set by the supervision personnel based on experience.

In some embodiments, the management platform may capture real-time bridge images through an image-capturing device (e.g., a camera, etc.) set up on the bridge, and utilize techniques such as image recognition to identify and process the bridge images to obtain the first traffic flow data.

The bridge safety coefficient characterizes a safety level of the bridge under a current load.

In some embodiments, the management platform may determine the bridge safety coefficient in a plurality of manners. For example, for each of the plurality of historical time points in a predetermined time period prior to the current time point, the management platform may determine the count of pedestrians and the count of vehicles at the historical time point based on the first traffic flow data, and determine a pedestrian load and a traffic load at the historical time point based on the count of pedestrians and the count of vehicles to obtain a total load at the historical time point.

The pedestrian load at each of the historical time points is a product of the count of pedestrians and an average pedestrian weight at the historical time point; the traffic load at each of the historical time points is a product of the count of vehicles and an average vehicle weight at the historical time point; and the total load at each of the historical time points is a sum of the pedestrian load and the traffic load at the historical time point. The average vehicle weight and the average pedestrian weight may be set by the supervision personnel based on experience.

The management platform may obtain the total load at each of the plurality of historical time points in the predetermined time period based on the above manner, determine a ratio of a reference load to the total load at each of the plurality of historical time points separately, and take an average of the ratios as the bridge safety coefficient. The reference load may be set by the supervision personnel based on experience.

In some embodiments, the management platform may determine the bridge safety coefficient through a simulation model based on the first traffic flow data and first environmental data.

The first environmental data refers to environmental data at the plurality of historical time points in the predetermined time period prior to the current time point. The environmental data may include a wind speed, a wind direction, a snowfall, a temperature, etc. In some embodiments, the first environmental data may be obtained through a third-party platform (e.g., a meteorological platform).

In some embodiments, the simulation model may be a machine learning model. For example, the simulation model may be a Deep Neural Network (DNN) model, a customized model, or the like, or any combination thereof.

In some embodiments, the simulation model may be obtained by training based on a plurality of first training samples with first labels. For example, the plurality of first training samples with the first labels may be input to an initial simulation model, a loss function is constructed from the first labels and results of the initial simulation model, and parameters of the initial simulation model are iteratively updated based on the loss function by gradient descent or other manners. The model training is completed until a preset condition is satisfied, and a trained simulation model is obtained. The preset condition may include that the loss function converges, a count of iterations reaches a threshold, etc.

In some embodiments, a first training sample may include historical first traffic flow data and historical first environmental data of the bridge in a plurality of historical time periods, and the first training samples may be obtained based on historical data.

In some embodiments, the first label of a first training sample may include an actual bridge safety coefficient corresponding to the first training sample. The first label may be constructed in the following manner. For the first training sample corresponding to the plurality of historical time periods, a ratio of a first average displacement of the bridge during a first historical time period to a difference between the first average displacement and a second average displacement of the bridge during a second historical time period is designated as the first label. The first historical time period precedes the second historical time period. The first average displacement refers to an average of the displacements of the plurality of target locations on the bridge during the first historical time period, caused by vibrations or applied loads (e.g., pedestrian loads and vehicle loads). The second average displacement refers to an average of the displacements of the plurality of target locations on the bridge during the second historical period, caused by vibrations or applied loads. The displacements of the plurality of target locations on the bridge may be obtained by a plurality of GPS displacement sensors. More descriptions regarding the GPS displacement sensors may be found in FIG. 2 and related descriptions thereof.

It may be understood that vibrations or applied loads, etc., may cause deformations or cracks in the bridge (e.g., the plurality of target locations on the bridge, etc.), thus adversely affecting the health status of the bridge.

In some embodiments of the present disclosure, determining the bridge safety coefficient through the trained simulation model based on the first traffic flow data and the first environmental data not only improves the practical relevance of the bridge safety coefficient but also effectively ensures the accuracy of prediction results of the simulation model.

In 230, a bridge reliability level is determined based on the bridge health value and the bridge safety coefficient.

The bridge reliability level characterizes a degree to which the bridge is able to safely carry loads and functions normally in its current state.

In some embodiments, the management platform may perform normalization processing on the bridge health value and the bridge safety coefficient, and perform a weighted summation on a result of the normalization processing to obtain the bridge reliability level.

The normalization processing may include Min-Max normalization, etc. Weight coefficients in the weighted summation may be set by the supervision personnel based on experience. In some embodiments, the weight coefficient of the bridge safety coefficient is positively correlated to an average value of the pedestrian flows and/or the vehicle flows at the plurality of historical time points in the predetermined time period. For example, the higher the average value of the pedestrian flows and the vehicle flows is, the higher the weight coefficient of the bridge safety coefficient is. It may be understood that the higher the average value of the pedestrian and/or the vehicle flow is, the higher the weighting coefficient of the bridge safety coefficient is, indicating that the bridge is more susceptible to deterioration or damage as the bridge is subjected to a high load for a long period of time. Therefore, the weight coefficient of the bridge safety coefficient needs to be increased.

In 240, in response to the bridge reliability level satisfying a first predetermined condition, at least one of a signal light regulation instruction, a maintenance regulation instruction, or a traffic regulation instruction is generated.

The first predetermined condition refers to a condition for determining whether to generate a regulation instruction. The regulation instruction may include at least one of a signal light regulation instruction, a maintenance regulation instruction, a traffic regulation instruction, etc. In some embodiments, the first predetermined condition may include the bridge reliability level being less than a normal threshold and greater than an abnormal threshold, or the bridge reliability level being less than an abnormal threshold, etc. The normal threshold is greater than the abnormal threshold, and the normal threshold and the abnormal threshold may be predetermined by the supervision personnel based on experience.

The signal light regulation instruction refers to an instruction for regulating a plurality of traffic signal lights. In some embodiments, the signal light regulation instruction is configured to control each of the plurality of traffic signal lights to display a predetermined color in a predetermined time period. The predetermined time period refers to a pre-defined duration for traffic signal display. The predetermined color of traffic signal light refers to a pre-specified color to be displayed by the traffic signal light.

In some embodiments, the management platform may send the signal light regulation instruction to an emergency supervision object platform (e.g., the emergency supervision object platform 150) through an emergency supervision sensor network platform (e.g., the emergency supervision sensor network platform 140), and the emergency supervision object platform may control each of the plurality of traffic signal lights to display the predetermined color in the predetermined time period based on the signal light regulation instruction.

The maintenance regulation instruction refers to an instruction for controlling a plurality of maintenance robots to maintain the bridge. In some embodiments, the maintenance regulation instruction is configured to control the plurality of maintenance robots to inject an adhesive and/or perform steel plate bonding at predetermined locations on the bridge, etc. The predetermined locations may be locations on the bridge that needs to be reinforced. For example, the predetermined locations may be locations on the bridge with cracks, fractures, deformations, etc. The adhesive may include one of epoxy resin, polyurethane grout, etc.

In some embodiments, the management platform may send the maintenance regulation instruction to the emergency supervision object platform through the emergency supervision sensor network platform, and the emergency supervision object platform may control a predetermined count of maintenance robots to travel to the predetermined locations and inject adhesives into the cracks on the bridge; and/or bond steel plates to the fractures on the bridge by welding or bolting, etc.

The predetermined count of maintenance robots may be set based on actual requirements, and a distance between each of the predetermined count of maintenance robots and the predetermined location (i.e., the location to which the maintenance robot is assigned to perform maintenance) corresponding to the maintenance robot is less than a distance threshold, wherein the distance threshold may be set by the supervision personnel based on experience.

The traffic regulation instruction refers to an instruction for regulating a plurality of smart barricades on the bridge to perform traffic control on a plurality of bridge lanes. In some embodiments, the traffic regulation instruction is configured to control the plurality of smart barricades to be raised.

In some embodiments, the management platform may send the traffic regulation instruction to the emergency supervision object platform through the emergency supervision sensor network platform, and the emergency supervision object platform may control the plurality of smart barricades at two ends of the bridge to rise based on the traffic regulation instruction, thereby making the plurality of bridge lanes impassable. After completion of the traffic control, the plurality of smart barricades are lowered to allow vehicles to pass.

In some embodiments, the management platform may generate at least one of the signal light regulation instruction, the maintenance regulation instruction, or the traffic regulation instruction in a plurality of ways.

For example, in response to the bridge reliability level being less than the normal threshold and greater than the abnormal threshold, the management platform may generate the signal light regulation instruction and the traffic regulation instruction based on the bridge reliability level by querying a second predetermined table to regulate the pedestrian flow and the vehicle flow on the bridge. The second predetermined table may be set by the supervision personnel based on experience. The second predetermined table includes a plurality of different reliability ranges and signal light reference instructions and traffic reference instructions corresponding to the plurality of different reliability ranges.

Merely by way of example, the management platform may determine the reliability range in which the bridge reliability level falls based on the bridge reliability level by querying the second predetermined table, and determine the signal light reference instruction and the traffic reference instruction corresponding to the reliability level range as the signal light regulation instruction and the traffic regulation instruction, respectively.

As another example, in response to the bridge reliability level being less than the abnormal threshold, the management platform may generate the maintenance regulation instruction and the traffic regulation instruction by querying a third predetermined table based on the bridge reliability level. The third predetermined table may be set by the supervision personnel based on experience. The third predetermined table may include a plurality of reliability ranges, counts of reference reinforcement points corresponding to the plurality of reliability ranges, a location of each of the reference reinforcement points, and a required reference reinforcement material (injecting the adhesive and/or performing steel plate bonding, etc.) for each of the reference reinforcement points. The locations of the reference reinforcement points may be labeled by the supervision personnel based on a bridge design drawing.

Merely by way of example, the management platform may determine the reliability range in which the bridge reliability level falls based on the bridge reliability level by querying the third predetermined table, and determine the count of reference reinforcement points corresponding to the reliability range, the locations of the reference reinforcement points, and the required reference reinforcement materials for the reference reinforcement points, as the maintenance regulation instruction.

It may be understood that the plurality of maintenance robots are configured to perform temporary reinforcement on the bridge to avoid accidents before the supervision personnel arrives. Subsequently, the supervision personnel may perform further reinforcement based on the locations with cracks, fractures, or deformations in the bridge.

In some embodiments of the present disclosure, determining the bridge health value based on the sensing data can detect the deformation of the bridge in real time to avoid accidents; determining the bridge safety coefficient based on the first traffic flow data allows assessment of the load-bearing capability of the bridge under the current load to avoid overloading; determining the bridge reliability level based on the bridge health value and the bridge safety coefficient and generating the regulation instruction (e.g., the signal light regulation instruction, the maintenance regulation instruction, and the traffic regulation instruction) based on the bridge reliability level facilitates timely traffic management on bridge lanes and/or structural reinforcement. The integrated approach effectively ensures the bridge reliability level and safety of the bridge while preventing potential accidents.

In some embodiments, the management platform may obtain an adjusted instruction by adjusting the signal light regulation instruction based on traffic flow-related data, the bridge damage data, and reference damage data; and control each of the plurality of traffic signal lights to display the predetermined color in the predetermined time period based on the adjusted instruction.

The traffic flow-related data refers to data characterizing an impact of the pedestrian flow and/or the vehicle flow on bridge damage. More descriptions regarding the traffic flow-related data may be found in FIG. 3 and related descriptions thereof.

More descriptions regarding the bridge damage data may be found in operation 210 and related descriptions thereof.

The reference damage data refers to a maximum tolerable volume of cracks and deformations that the bridge can withstand under normal load conditions. In some embodiments, the reference damage data may be obtained through a simulation technique (e.g., a finite element analysis), etc.

The adjusted instruction refers to an instruction obtained after adjusting the signal light regulation instruction.

In some embodiments, the management platform may determine a maximum tolerable pedestrian flow and a maximum tolerable vehicle flow that the bridge withstands based on the traffic flow-related data (e.g., a pedestrian flow-damage change value curve and a traffic flow-damage change value curve) and a difference between the bridge damage data and the reference damage data; determine a pedestrian flow range and a vehicle flow range in which the pedestrian flow and the traffic flow falls respectively based on the maximum tolerable pedestrian flow and the maximum tolerable vehicle flow by querying a fourth predetermined table; and determine a reference adjusted instruction corresponding to the pedestrian flow range and the traffic flow range as the adjusted instruction. More descriptions regarding the pedestrian flow-damage change value curve and the traffic flow-damage change value curve may be found in FIG. 3 and related descriptions thereof.

The fourth predetermined table may be set by the supervision personnel based on experience. The fourth predetermined table includes a plurality of pedestrian flow ranges, a plurality of traffic flow ranges, and reference adjusted instructions corresponding to the plurality of pedestrian flow ranges and the plurality of traffic flow ranges.

The manner for controlling the plurality of traffic signal lights based on the adjusted instruction is the same as the manner for controlling the plurality of traffic signal lights based on the signal light regulation instruction. More descriptions may be found in the related descriptions above.

In some embodiments of the present disclosure, dynamically adjusting the display color and display period of the traffic signal lights based on the traffic flow-related data, the bridge damage data, and the reference damage data enables real-time monitoring of the bridge load and making corresponding adjustments. This approach provides rapid emergency response and effectively prevents accidents.

In some embodiments, in response to the bridge reliability level not satisfying a second predetermined condition, the management platform may generate a monitoring and regulating instruction, arrange a plurality of sensors at a plurality of locations on the bridge based on the monitoring and regulating instruction, and control the plurality of sensors to perform data acquisition at a predetermined acquisition frequency and/or data upload at a predetermined upload frequency. More descriptions regarding the bridge reliability level may be found in operation 230 and related descriptions thereof.

The second predetermined condition refers to a condition for determining whether the monitoring and regulating instruction needs to be generated. For example, the second predetermined condition may include the bridge reliability level being greater than the normal threshold. More descriptions regarding the normal threshold may be found in operation 240 and related descriptions thereof.

The monitoring and regulating instruction refers to an instruction for configuring sensors. In some embodiments, the monitoring and regulating instruction may be configured to determine locations of added sensors and types of the added sensors, and control a plurality of sensors to perform data acquisition at the predetermined acquisition frequency and/or to perform data upload at the predetermined upload frequency. The predetermined acquisition frequency and the predetermined upload frequency refer to a frequency at which the plurality of sensors acquire the sensing data and a frequency at which the plurality of sensors upload the sensing data, respectively.

In some embodiments, the monitoring and regulating instruction may be determined in a plurality of manners. For example, the supervision personnel may predetermine the locations of the added sensors and the types of the added sensors based on the bridge design drawing, and increase a current acquisition frequency and a current upload frequency of the plurality of sensors on the bridge by a predetermined adjustment amount to serve as the predetermined acquisition frequency and the predetermined upload frequency of the plurality of sensors, respectively. The predetermined adjustment amount may be set by the supervision personnel based on experience.

In some embodiments, in response to the bridge reliability level not satisfying the second predetermined condition, the management platform may generate the monitoring and regulating instruction based on the bridge damage data.

It may be understood that the supervision personnel may add a strain gauge and an acceleration sensor at a crack location of the bridge to acquire strains (including a dynamic strain and a static strain) and a vibration frequency at the crack location, and add a strain gauge and a GPS displacement sensors at a deformation location of the bridge to acquire strains (including a dynamic strain and a static strain) and a deformation magnitude at the deformation location.

In some embodiments, the management platform may determine, based on the bridge damage data, a damage data range in which the bridge damage data falls by querying a fifth predetermined table, and determine a reference acquisition frequency and a reference upload frequency of a plurality of reference sensors corresponding to the damage data range as the predetermined acquisition frequency and the predetermined upload frequency of the plurality of sensors.

The fifth predetermined table may be set by the supervision personnel based on experience. The fifth predetermined table may include a plurality of damage data ranges and reference acquisition frequencies and reference upload frequencies of the plurality of reference sensors corresponding to the plurality of damage data ranges.

In some embodiments of the present disclosure, matching the acquisition frequency and upload frequency of the plurality of sensors based on the bridge damage data helps prevent data redundancy or loss of critical information due to a fixed frequency, thereby enhancing subsequent risk response capabilities.

In some embodiments, the management platform may send the monitoring and regulating instruction to the emergency supervision object platform through the emergency supervision sensor network platform. The emergency supervision object platform may prompt the supervision personnel to add a plurality of sensors at a plurality of locations on the bridge based on the monitoring and regulating instruction.

The plurality of locations refer to installation locations of the added sensors. More descriptions regarding types of the sensors may be found in operation 210 and related descriptions thereof.

In some embodiments, the emergency supervision object platform may control the plurality of sensors to acquire the sensing data at the predetermined acquisition frequency and/or upload the sensing data at the predetermined upload frequency based on the monitoring and regulating instruction. More descriptions regarding the sensing data may be found in operation 210 and related descriptions thereof.

In some embodiments of the present disclosure, dynamically adding sensors based on the bridge reliability level and adjusting the acquisition frequency and the upload frequency of the sensors can prevent data redundancy or loss of critical information and ensure the validity of the sensing data, thereby facilitating improved emergency response speed in subsequent operations.

FIG. 3 is schematic diagram illustrating an exemplary damage prediction model according to some embodiments of the present disclosure.

The damage prediction model refers to a model for predicting bridge damage data. In some embodiments, the damage prediction model may be a machine learning model. For example, the damage prediction model may be a Deep Neural Network (DNN) model, a customized model, or the like, or any combination thereof.

In some embodiments, as shown in FIG. 3, an input of a damage prediction model 320 may include sensing data 311 of a plurality of target locations on a bridge, and an output of the damage prediction model 320 may include bridge damage data 330. More descriptions regarding the sensing data and the bridge damage data may be found in the operation 210 and related descriptions thereof.

In some embodiments, the damage prediction model may be obtained by training based on a plurality of second training samples with second labels. The training process of the damage prediction model is similar to the training process of the simulation model, as described in operation 220 and related descriptions thereof, which is not repeated here.

A second training sample includes a plurality of pieces of sensing data of a plurality of target locations of a sample bridge at a historical time point, and the second training sample may be obtained based on historical data. The second label includes actual bridge damage data corresponding to the second training sample. In some embodiments, the second label may be constructed in the following manner. Volumes and locations of actual cracks and deformations in the bridge may be obtained by ultrasonic testing, etc., at the historical time point corresponding to the second training sample, and the volumes and the locations of the actual cracks and deformations are designated as the second label of the second training sample.

In some embodiments of the present disclosure, determining the bridge damage data through the trained damage prediction model can reduce the frequency of manual ultrasonic inspections required to detect internal cracks and deformations in the bridge. This approach lowers costs and enhances the intelligent monitoring of the bridge health status.

In some embodiments, as shown in FIG. 3, the input of the damage prediction model 320 further includes a service time 312 of the bridge.

The service time of the bridge refers to the elapsed time since its commissioning. In some embodiments, the management platform may determine a difference between a current time point and a bridge completion time as the service time of the bridge. The bridge completion time may be uploaded by a supervision personnel through an emergency supervision user platform (e.g., a terminal device).

In some embodiments, if the input of the damage prediction model includes the service time of the bridge, the second training sample of the damage prediction model further includes an actual service time of the sample bridge at a historical time point when the service time of the sample bridge was determined.

It may be understood that the service time of the bridge may reflect, to some extent, a wear degree of each structural component of the bridge. Therefore, the output accuracy of the damage prediction model can be further increased by incorporating the service time of the bridge as the input to the damage prediction model.

In some embodiments, as shown in FIG. 3, the input of the damage prediction model 320 further includes a traffic flow impact feature 313 and an environmental impact feature 314.

In some embodiments, the management platform may determine traffic flow-related data and environment-related data based on historical damage data, second traffic flow data, and second environmental data, and determine the traffic flow impact feature and the environmental impact feature based on the first traffic flow data, the first environmental data, the traffic flow-related data, and the environment-related data. More descriptions regarding the first traffic flow data and the first environmental data may be found elsewhere in the present disclosure (e.g., descriptions relating to FIG. 2).

The historical damage data refers to change values of the bridge damage data in a historical time period. For example, the historical damage data may include the change values of the volumes of cracks and deformations in the bridge in the historical time period, etc.

The second traffic flow data refers to pedestrian flows and vehicle flows corresponding to the historical damage data in the historical time period. For example, the second traffic flow data may be an average value of the pedestrian flows and an average value of the vehicle flows at a plurality of historical time points in the historical time period.

The second environmental data refers to environmental data corresponding to the historical damage data in the historical time period. For example, the second environmental data may be average values of wind speeds, wind directions, snowfall amounts, temperatures, etc., at the plurality of historical time points in the historical time period.

More descriptions regarding the traffic flow-related data may be found in FIG. 2 and related descriptions thereof. In some embodiments, the traffic flow-related data may be represented in the form of a two-dimensional curve with a vertical coordinate representing damage change values and a horizontal coordinate representing pedestrian flows and/or vehicle flows. The damage change value refers to a difference between bridge damage data at a current time point and bridge damage data at a previous time point (i.e., the change value of the bridge damage data described above).

Merely by way of example, the management platform may construct a plurality of numerical points based on a plurality of pedestrian flows and damage change values corresponding to the plurality of pedestrian flows, sort the plurality of numerical points and the corresponding pedestrian flows in ascending order, and perform fitting on the plurality of numerical points to obtain a pedestrian flow-damage change value curve. A fitting model may include one of linear regression, polynomial regression, etc., and a fitting algorithm may include one of least squares, maximum likelihood estimation, etc. A traffic flow-damage change value curve may be constructed in a manner similar to the manner for constructing the pedestrian flow-damage change value curve, which is not repeated here.

The environment-related data refers to data characterizing an impact of environmental data on bridge damage. In some embodiments, the environment-related data may also be represented in the form of a two-dimensional curve with a vertical coordinate representing damage change values and a horizontal coordinate representing environmental data. An environmental data-damage change value curve may be constructed in a manner similar to the manner for constructing the pedestrian flow-damage change value curve described above, which is not repeated here.

The traffic flow impact feature characterizes an impact of the pedestrian flow and/or the traffic flow in the first traffic flow data on bridge damage. For example, the traffic flow impact feature may include a plurality of time points corresponding to the first traffic flow data and damage change values corresponding to the plurality of time points.

The environmental impact feature characterizes an impact of the environmental data in the first environmental data on bridge damage. For example, the environmental impact feature may include a plurality of time points corresponding to the first environmental data and damage change values corresponding to the plurality of time points.

More descriptions regarding the first traffic flow data and the first environmental data may be found in the related descriptions of operation 220.

In some embodiments, the management platform may determine the traffic flow impact feature based on the first traffic flow data and the traffic flow-related data. For example, based on pedestrian flows and/or vehicle flows at the plurality of time points corresponding to the first traffic flow data, the management platform may determine a plurality of damage change values corresponding to the pedestrian flows and/or the vehicle flows at the plurality of time points by querying the pedestrian flow-damage change value curve and/or the traffic flow-damage change value curve (i.e., the traffic flow-related data), and construct the traffic flow impact feature based on the plurality of time points, the damage change values, and the pedestrian flow and/or the traffic flow corresponding to each other.

In some embodiments, the management platform may determine the environmental impact feature based on the first environmental data and the environment-related data. The manner for determining the environmental impact feature is similar to the manner for determining the traffic flow impact feature described above, which is not described here.

In some embodiments, if the input of the damage prediction model includes the traffic flow impact feature and the environmental impact feature, the second training sample of the damage prediction model further includes an actual traffic flow impact feature and an actual environmental impact feature of the sample bridge at the corresponding historical time point.

It may be understood that the traffic flow impact feature can reflect, to some extent, to load-induced damages (e.g., structural fatigue, crack propagation, and deformation expansion caused by traffic loads, etc.), and the environmental impact feature can reflect environment-induced damages (e.g., wind-induced vibrations amplifying cracks, snow accumulation increasing localized deformation volume, etc.). Therefore, the output accuracy of the damage prediction model can be further improved by incorporating the flow impact feature and the environmental impact feature as the input of the damage prediction model.

Embodiments of the present disclosure further provide a non-transitory computer-readable storage medium storing computer instructions. When reading the computer instructions in the storage medium, a computer implements the method for emergency supervision of a bridge in a smart city described above.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Furthermore, the recited order of processing elements or sequences, or the use of numbers, letters, or other designations thereof, are not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A large model-based system of Internet of Things (IoT) for emergency supervision of a bridge in a smart city, wherein the system comprises an emergency supervision user platform, an emergency supervision service platform, an emergency supervision management platform, an emergency supervision sensor network platform, and an emergency supervision object platform;
the emergency supervision management platform is configured to:
determine a bridge health value of the bridge based on sensing data of a plurality of target locations on the bridge;
determine a bridge safety coefficient based on first traffic flow data of the bridge;
determine a bridge reliability level based on the bridge health value and the bridge safety coefficient;
in response to the bridge reliability level satisfying a first predetermined condition, generate at least one of a signal light regulation instruction, a maintenance regulation instruction, or a traffic regulation instruction; wherein
the signal light regulation instruction is configured to control each of a plurality of traffic signal lights to display a predetermined color in a predetermined time period;
the maintenance regulation instruction is configured to control a plurality of maintenance robots to inject an adhesive and/or perform steel plate bonding at predetermined locations on the bridge; and
the traffic regulation instruction is configured to control a plurality of smart barricades to be raised.

2. The system of claim 1, wherein the emergency supervision management platform is further configured to:
determine the bridge safety coefficient through a simulation model based on the first traffic flow data and first environmental data, the simulation model being a machine learning model.

3. The system of claim 1, wherein the emergency supervision management platform is further configured to:
determine bridge damage data of the bridge through a damage prediction model based on the sensing data, the damage prediction model being a machine learning model; and
determine the bridge health value based on the bridge damage data.

4. The system of claim 3, wherein an input of the damage prediction model includes a service time of the bridge.

5. The system of claim 3, wherein an input of the damage prediction model includes a traffic flow impact feature and an environmental impact feature;
the emergency supervision management platform is further configured to:
determine traffic flow-related data and environment-related data based on historical damage data, second traffic flow data, and second environmental data; and
determine the traffic flow impact feature and the environmental impact feature based on the first traffic flow data, the first environmental data, the traffic flow-related data, and the environment-related data.

6. The system of claim 5, wherein the emergency supervision management platform is further configured to:
obtain an adjusted instruction by adjusting the signal light regulation instruction based on the traffic flow-related data, the bridge damage data, and reference damage data; and
control each of the plurality of traffic signal lights to display the predetermined color in the predetermined time period based on the adjusted instruction.

7. The system of claim 1, wherein the emergency supervision management platform is further configured to:
in response to the bridge reliability level not satisfying a second predetermined condition, generate a monitoring and regulating instruction, and arrange a plurality of sensors at a plurality of locations on the bridge based on the monitoring and regulating instruction, and
control the plurality of sensors to perform data acquisition at a predetermined acquisition frequency and/or data upload at a predetermined upload frequency.

8. The system of claim 7, wherein the emergency supervision management platform is further configured to:
in response to the bridge reliability level not satisfying the second predetermined condition, generate the monitoring and regulating instruction based on bridge damage data.

9. A method for emergency supervision of a bridge in a smart city, the method being executed by an emergency supervision management platform at a predetermined interval and comprising:
determining a bridge health value of the bridge based on sensing data of a plurality of target locations on the bridge;
determining a bridge safety coefficient based on first traffic flow data of the bridge;
determining a bridge reliability level based on the bridge health value and the bridge safety coefficient;
in response to the bridge reliability level satisfying a first predetermined condition, generating at least one of a signal light regulation instruction, a maintenance regulation instruction, or a traffic regulation instruction; wherein
the signal light regulation instruction is configured to control each of a plurality of traffic signal lights to display a predetermined color in a predetermined time period;
the maintenance regulation instruction is configured to control a plurality of maintenance robots to inject an adhesive and/or perform steel plate bonding at predetermined locations on the bridge; and
the traffic regulation instruction is configured to control a plurality of smart barricades to be raised.

10. The method of claim 9, wherein the determining a bridge safety coefficient based on first traffic flow data of the bridge includes:
determining the bridge safety coefficient through a simulation model based on the first traffic flow data and first environmental data, the simulation model being a machine learning model.

11. The method of claim 9, wherein the determining a bridge health value of the bridge based on sensing data of a plurality of target locations on the bridge includes:
determining bridge damage data of the bridge through a damage prediction model based on the sensing data, the damage prediction model being a machine learning model; and
determining the bridge health value based on the bridge damage data.

12. The method of claim 11, wherein an input of the damage prediction model includes a service time of the bridge.

13. The method of claim 11, wherein an input of the damage prediction model includes a flow impact feature and an environmental impact feature;
the method further comprises:
determining traffic flow-related data and environment-related data based on historical damage data, second traffic flow data, and second environmental data; and
determining the flow impact feature and the environmental impact feature based on the first traffic flow data, the first environmental data, the traffic flow-related data, and the environment-related data.

14. The method of claim 13, further comprising:
obtaining an adjusted instruction by adjusting the signal light regulation instruction based on the traffic flow-related data, the bridge damage data, and reference damage data; and
controlling each of the plurality of traffic signal lights to display the predetermined color in the predetermined time period based on the adjusted instruction.

15. The method of claim 9, further comprising:
in response to the bridge reliability level not satisfying a second predetermined condition, generating a monitoring and regulating instruction, and arranging a plurality of sensors at a plurality of locations on the bridge based on the monitoring and regulating instruction, and
controlling the plurality of sensors to perform data acquisition at a predetermined acquisition frequency and/or data upload at a predetermined upload frequency.

16. The method of claim 15, wherein the in response to the bridge reliability level not satisfying a second predetermined condition, generating a monitoring and regulating instruction, includes:
in response to the bridge reliability level not satisfying the second predetermined condition, generating the monitoring and regulating instruction based on bridge damage data.

17. A non-transitory computer-readable storage medium storing computer instructions, wherein when reading the computer instructions in the storage medium, a computer implements a method for emergency supervision of a bridge in a smart city, the method being executed by an emergency supervision management platform at a predetermined interval and comprising:
determining a bridge health value of the bridge based on sensing data of a plurality of target locations on the bridge;
determining a bridge safety coefficient based on first traffic flow data of the bridge;
determining a bridge reliability level based on the bridge health value and the bridge safety coefficient;
in response to the bridge reliability level satisfying a first predetermined condition, generating at least one of a signal light regulation instruction, a maintenance regulation instruction, or a traffic regulation instruction; wherein
the signal light regulation instruction is configured to control each of a plurality of traffic signal lights to display a predetermined color in a predetermined time period;
the maintenance regulation instruction is configured to control a plurality of maintenance robots to inject an adhesive and/or perform steel plate bonding at predetermined locations on the bridge; and
the traffic regulation instruction is configured to control a plurality of smart barricades to be raised.
